(19) United States
(12) Patent Application Publication
(10) Pub. No.: US 2013/0073300 A1
(43) Pub. Date: Mar. 21, 2013

(54) Apparatus and Method Pertaining to Anesthesiology-Related-Event Information Processing

(71) Applicants: Lex WOLF, New York, NY (US); Barry MATHEWS, Plainfield, IL (US); Howard SCHECHTER, Highland Park, IL (US); Madison SAMPLE, JR., Long Grove, IL (US)

(72) Inventors: Lex WOLF, New York, NY (US); Barry MATHEWS, Plainfield, IL (US); Howard SCHECHTER, Highland Park, IL (US); Madison SAMPLE, JR., Long Grove, IL (US)

(21) Appl. No.: 13/238,677

(22) Filed: Sep. 21, 2011

(51) Int. Cl. G06Q 50/00

(52) U.S. Cl. 705/2

(57) ABSTRACT

Anesthesiology-services providers (such as anesthesiologists or corresponding physician extenders) are provided with a portable, handheld apparatus to facilitate the timely entry of information regarding anesthesiology-related events. To facilitate the data-entry process, this can include receiving inputs from an anesthesiologist via an end-user interface regarding at least one anesthesiology-related event and storing that information. Then, for at least some of these inputs, selectively characterizing one or more follow-on input opportunities by which the anesthesiologist can enter additional information regarding the anesthesiology-related event.

### TECHNICAL FIELD

This disclosure relates generally to data collection and processing and more particularly to information pertaining to anesthesiology-related events.

### BACKGROUND

Numerous medical practices are best performed with an anesthetized patient. The medical practitioner who performs the medical procedure is typically not also the person who attends to the anesthetization of the patient. Instead, a trained and licensed anesthesiologist (typically an MD or a DO) attends to the patient's anesthetization.

The anesthesiologist's services in these regards drives a need for a considerable amount of recordkeeping. Various details regarding the anesthesiologist's services as well as certain circumstances regarding the patient's particular needs or presentations are needed to calculate an appropriate bill for the anesthesiologist's services. In addition, other information may be necessary to calculate the anesthesiologist's personal compensation (when, for example, a service-provider organization employs the anesthesiologist and provides for the anesthesiologist's compensation). Beyond this, it can be important to maintain a record of any number of circumstances as tend to characterize a given anesthesiology-related event in order to accurately represent those circumstances should subsequent post-operation inquiries be appropriate.

Numerous recordkeeping methodologies are known in the art. Notwithstanding the relative plethora of solutions in these regards, however, the applicants have determined that none of these prior approaches is necessarily suitable to meet all recording and reporting needs as pertain to anesthesiology-related events.

### BRIEF DESCRIPTION OF THE DRAWINGS

The above needs are at least partially met through provision of the apparatus and method pertaining to anesthesiology-related-event information processing described in the following detailed description, particularly when studied in conjunction with the drawings, wherein:

FIG. 1 comprises a block diagram as configured in accordance with various embodiments of the invention;

FIG. 2 comprises a perspective view as configured in accordance with various embodiments of the invention;

FIG. 3 comprises a top plan view as configured in accordance with various embodiments of the invention;

FIG. 4 comprises a screen shot as configured in accordance with various embodiments of the invention;

FIG. 5 comprises a screen shot as configured in accordance with various embodiments of the invention;

FIG. 6 comprises a screen shot as configured in accordance with various embodiments of the invention;

FIG. 7 comprises a screen shot as configured in accordance with various embodiments of the invention;

FIG. 8 comprises a screen shot as configured in accordance with various embodiments of the invention;

FIG. 9 comprises a screen shot as configured in accordance with various embodiments of the invention;

FIG. 10 comprises a screen shot as configured in accordance with various embodiments of the invention;

FIG. 11 comprises a flow diagram as configured in accordance with various embodiments of the invention;

FIG. 12 comprises a screen shot as configured in accordance with various embodiments of the invention;

FIG. 13 comprises a screen shot as configured in accordance with various embodiments of the invention;

FIG. 14 comprises a screen shot as configured in accordance with various embodiments of the invention;

FIG. 15 comprises a screen shot as configured in accordance with various embodiments of the invention;

FIG. 16 comprises a screen shot as configured in accordance with various embodiments of the invention;

FIG. 17 comprises a screen shot as configured in accordance with various embodiments of the invention;

FIG. 18 comprises a screen shot as configured in accordance with various embodiments of the invention;

FIG. 19 comprises a screen shot as configured in accordance with various embodiments of the invention;

FIG. 20 comprises a screen shot as configured in accordance with various embodiments of the invention;

FIG. 21 comprises a screen shot as configured in accordance with various embodiments of the invention;

FIG. 22 comprises a screen shot as configured in accordance with various embodiments of the invention;

FIG. 23 comprises a screen shot as configured in accordance with various embodiments of the invention;

FIG. 24 comprises a screen shot as configured in accordance with various embodiments of the invention;

FIG. 25 comprises a screen shot as configured in accordance with various embodiments of the invention;

FIG. 26 comprises a screen shot as configured in accordance with various embodiments of the invention;

FIG. 27 comprises a screen shot as configured in accordance with various embodiments of the invention;

FIG. 28 comprises a screen shot as configured in accordance with various embodiments of the invention;

FIG. 29 comprises a screen shot as configured in accordance with various embodiments of the invention;

FIG. 30 comprises a screen shot as configured in accordance with various embodiments of the invention;

FIG. 31 comprises a screen shot as configured in accordance with various embodiments of the invention;

FIG. 32 comprises a screen shot as configured in accordance with various embodiments of the invention;

FIG. 33 comprises a screen shot as configured in accordance with various embodiments of the invention;

FIG. 34 comprises a screen shot as configured in accordance with various embodiments of the invention;

FIG. 35 comprises a screen shot as configured in accordance with various embodiments of the invention;

FIG. 36 comprises a screen shot as configured in accordance with various embodiments of the invention;

FIG. 37 comprises a screen shot as configured in accordance with various embodiments of the invention;

FIG. 38 comprises a screen shot as configured in accordance with various embodiments of the invention;

FIG. 39 comprises a screen shot as configured in accordance with various embodiments of the invention;

FIG. 40 comprises a screen shot as configured in accordance with various embodiments of the invention;

FIG. 41 comprises a screen shot as configured in accordance with various embodiments of the invention;

FIG. 42 comprises a screen shot as configured in accordance with various embodiments of the invention;

FIG. 43 comprises a screen shot as configured in accordance with various embodiments of the invention;

FIG. 44 comprises a screen shot as configured in accordance with various embodiments of the invention;

FIG. 45 comprises a screen shot as configured in accordance with various embodiments of the invention;

FIG. 46 comprises a screen shot as configured in accordance with various embodiments of the invention;

FIG. 47 comprises a screen shot as configured in accordance with various embodiments of the invention;

FIG. 48 comprises a screen shot as configured in accordance with various embodiments of the invention; and

FIG. 49 comprises a screen shot as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, anesthesiology-services providers (such as anesthesiologists or corresponding physician extenders) are each provided with a portable, handheld apparatus to facilitate the timely entry of information regarding anesthesiology-related events. To facilitate the data-entry process, this can include receiving inputs from an anesthesiologist via an end-user interface regarding at least one anesthesiology-related event and storing that information. Then, for at least some of these inputs, selectively characterizing one or more follow-on input opportunities by which the anesthesiologist can enter additional information regarding the anesthesiology-related event.

So configured, the time required to enter relevant information can be considerably reduced. These approaches can also aid in ensuring both the accuracy and completeness of entered information.

The particular information gleaned can of course vary with the needs of the application setting. By one approach this can include information useful to calculate an anesthesiologist-patient bill. By another approach, in lieu of the foregoing or in combination therewith, this can include information useful to calculate compensation for the anesthesiologist but which information is not useful to calculate the anesthesiologist-patient bill. As yet another example in these regards, this can include information that may not be particularly relevant to the patient's bill or the anesthesiologist's compensation but which can nevertheless be helpful to later assessing procedural compliance, operational efficiencies, and so forth.

These teachings are readily fielded and can serve to greatly leverage the availability and capabilities of numerous existing user platforms (such as so-called smartphones (such as the iPhone and Droids), tablet-based platforms (such as Apple's iPad), laptop computers, netbook computers, and so forth). By one approach, for example, the client-side programming to facilitate these teachings can be rendered available to a user population as a downloadable application (often popularly referred to as an “app”) for a given corresponding device such as an iPad.

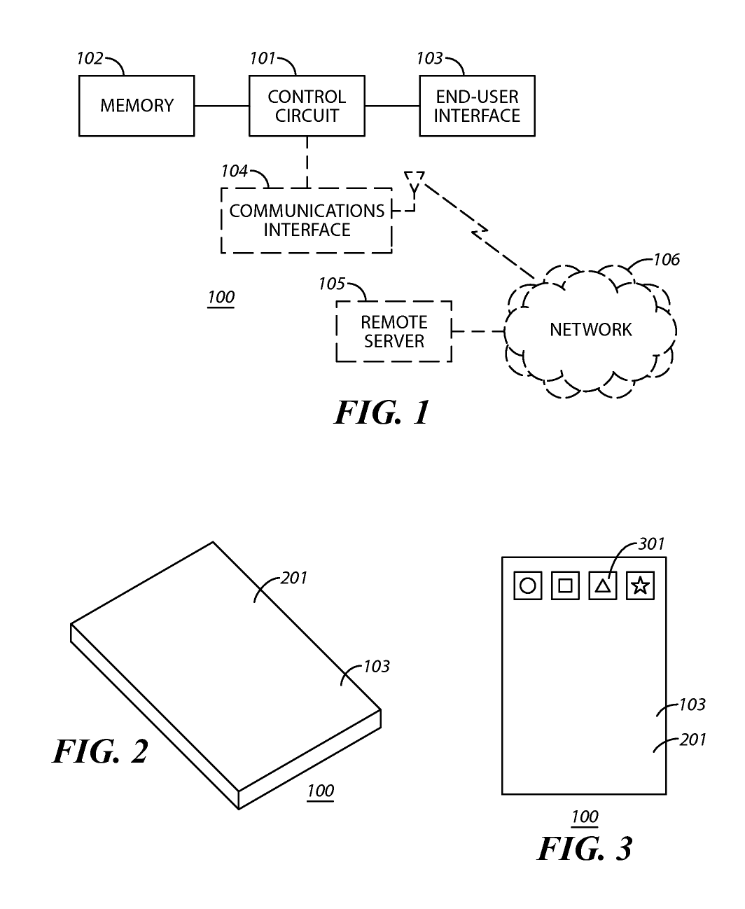

These and other benefits may become clearer upon making a thorough review and study of the following detailed description. The processes described herein are readily enabled using any of a wide variety of available and/or readily configured platforms. FIG. 1 provides an illustrative example in these regards of an enabling device 100.

Generally speaking, this device 100 comprises a control circuit 101 that operably couples to a memory 102 and an end-user interface 103. Such a control circuit 101 can comprise a fixed-purpose hard-wired platform or can comprise a partially or wholly programmable platform as desired. These architectural options are well known and understood in the art and require no further description here.

The memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101.

This memory 102 can serve, for example, to non-transitorily store the computer instructions that, when executed by the control circuit 101, cause the control circuit 101 to behave as described herein by carrying out one or more of the described actions, tasks, or functions. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM)).

This memory 102 can also serve, if desired, to store local user data including entries made by an end user of the device 100 as described herein.

The end-user interface 103 will typically serve both to receive input from the end user and also to convey information to that end user. Examples of suitable input mechanisms include, but are not limited to, touch-screen displays, keyboards and keypads, cursor control devices of various kinds, speech-recognition modules, and so forth. Examples of suitable output mechanisms include, but are not limited to, any of a variety of displays (including the aforementioned touch-screen display), signal lights, hard-copy printers, text-to-speech audibilization modules, and so forth. The specific end-user interface 103 selected in a given instance can of course vary with the needs and/or opportunities as tend to characterize a given application setting.

For many application settings it will be useful to provide the device 100 with a one-way or two-way communications capability. Accordingly, these teachings will accommodate including a communications interface 104 that also operably couples to the control circuit 101. This communications interface 104 can comprise a wireless communications interface such as, for example, a relatively short-range interface (such as a Bluetooth-compatible transceiver), a relatively mid-range interface (such as a WiFi-compatible transceiver), or a relatively long-range interface (such as a cellular telephony-compatible transceiver). Such a wireless communications interface can utilize, if desired, an optical carrier to bear the desired communications. More typically, however, a radio-frequency carrier will likely prove useful in many application settings of value.

So configured, the device 100 can utilize the communications interface 104 to wirelessly communicate with one or more remote servers 105 (via, for example, one or more intervening communications networks such as a local WiFi network, the Internet, and so forth). This, in turn, can permit the remote server 105 to update the operating information used by the device 100 and the device 100 to upload information to the remote server 105 regarding anesthesiology-related events as per these teachings.

For many application settings it will be useful for the device 100 to comprise a portable device (that operates, for example, on a portable power source such as one or more batteries) that can be readily carried and manipulated by the end user. Smaller devices, such as smartphones, may be adequate in some cases. For many purposes, however, a larger device, such as a device having a housing that offers a tablet-based form factor, may be preferred. FIG. 2 illustrates such a device 100.

Tablet-based platforms (such as the iPad) typically offer an end-user interface 103 that includes a relatively large touch-screen display 201 that will readily support the actions and behaviors described herein. For the sake of illustration but without intending to suggest any particular limitations in these regards, the remainder of this description will presume that the device 100 comprises an Apple iPad.

Referring now to FIG. 3, in this illustrative example the end user (such as an anesthesiologist or corresponding physician extender) accesses the functionality described herein by selecting an appropriate application icon 301 as appears on the touch-screen display 201 of the device 100. As per the usual approach in these regards, the end user selects this icon 301 by momentarily tapping the icon 301 using, for example, a finger (not shown).

Referring now to FIG. 4, by one approach, upon initiation, the program can present the end user with a log-in screen. This can include, as illustrated, providing data-entry fields to enter the user's name or other identifier and a corresponding password using a virtual keyboard and to submit that information using a “Login” button. If desired, a remote server can previously establish an account for this particular end user and transfer corresponding authentication information to the device 100. So configured, the device 100 can then receive this log-in information and accept (or deny, as appropriate) the end user even when the device 100 is presently unable to communicate with that remote server.

In any event, by this approach or another, the device 100 logs in the end user (such as an anesthesiologist) as a previously-authorized user. This can help to preserve the integrity of the information ultimately entered by helping to ensure that only a pre-authorized person enters that information into a particular such device 100.

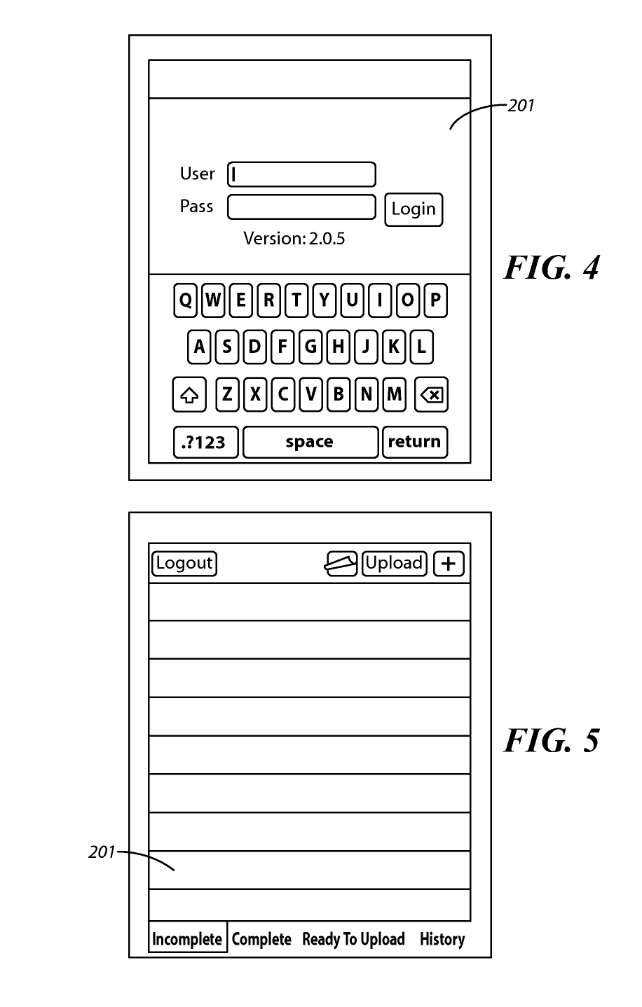

Referring now to FIG. 5, upon logging in the device 100 can present the end user with a number of options. This can include buttons or other selection icons pertaining to logging out, reviewing locally-stored historical content, preparing to upload information or instigating an upload, accessing a complete previously-entered record for a given anesthesiology-related event, and accessing a previously-created or creating a new presently-incomplete record (by asserting, in the latter case, the “Incomplete” tab and the “+” button). For the purposes of the present description it will be presumed that the user selects to create a new record.

It may be noted here that the program may ascertain, from the aforementioned log-in information, that the end user (who might be, for example, a relatively new or less-experienced employee) may not be permitted to create a new data-entry record and/or may not have unfettered personal freedom to enter data for all data-entry opportunities as a function of whether they have sufficient authorized status in these regards. Accordingly, the program can selectively permit, prohibit, or limit the end user with respect to entering additional information as a function of supervisory requirements that pertain to that end user.

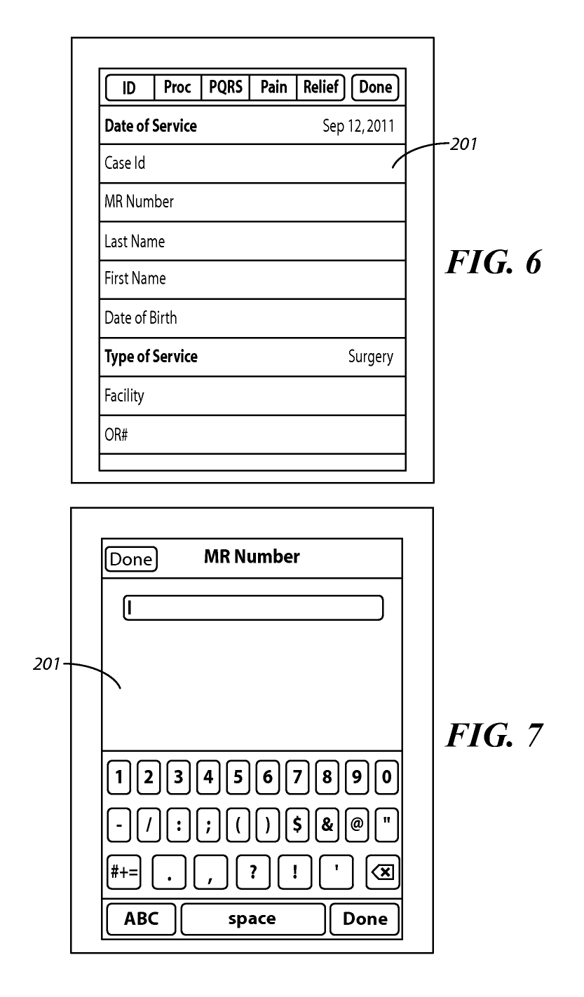

A complete record for a given anesthesiology-related event for a given end user comprises specific entries for a considerable number of data-entry opportunities. Referring to FIG. 6 the touch-screen display 201 presents a subset of these opportunities as a series of stacked brief descriptors that appear at the left side of the touch-screen display 201. Corresponding data entries (or at least an abbreviated or abridged representation thereof), when and as entered, appear at the right side of the touch-screen display 201 for each data-entry opportunity.

The device 100 can also be configured to parse the data-entry opportunities amongst a plurality of related data-entry types. In the illustrated example this comprises parsing the data-entry opportunities for a given anesthesiology-related event record amongst five selectable tabs (these being an “ID” tab where the end user enters general identification information, a “Proc” tab where the end user enters information regarding the procedure or procedures that give rise to the need for anesthesia, a “PQRS” tab where the end user enters information regarding a physical quality rating system, a “Pain” tab where the end user enters information regarding the patient's pain-related experience and treatment, and a “Relief” tab where the end user enters information regarding at least one additional anesthesiologist who may also participate in this particular anesthesiology-related event).

If desired, and as shown, default data entries can be pre-populated for at least some of the data-entry opportunities. In the illustration shown, for example, a default entry for the date of service (i.e., “Sep. 12, 2011) appears. This default entry can comprise, for example, the present date if desired. As another example, the “Type of Service” data-entry opportunity has the corresponding default entry “Surgery.” As will be shown below, the end user has the opportunity to modify these default entries when the default entries do not accurately reflect the circumstances pertaining to the anesthesiology-related event. By one approach these default entries can be fixed by the system administrator across the end-user population. By another approach the individual end users can be permitted to set their own preferred default settings.

In many application settings the end-user interface will be of insufficient size to adequately present all data-entry opportunities. Accordingly, and as shown, only a subset of these opportunities may appear at any one time. In this illustrative example it will be presumed that the end user can scroll through the data-entry opportunities by placing their finger on the touch-screen display 201 and moving their finger vertically to cause a desired amount of scrolling.

If desired, some data-entry opportunities can be required entries whereas other data-entry opportunities can be optional. Such a convention can be represented in any of a variety of ways (for example, by using different colors, font size, font type, or font emphasis to distinguish between required and optional entries). By way of illustration, and with continued reference to FIG. 6, the data-entry opportunities for “MR Number,” “Last Name,” “First Name,” “Date of Birth,” (where the name and birth date information pertains to the patient), and “Facility” can all be colored red to indicated their required status while the other data-entry opportunities can be colored a different color such as black.

Presentation differences can also serve to communicate whether a given data-entry opportunity is presently selectable by the end user for the entry of data. For example, the data-entry opportunity “OR #” (where the end user can identify which operating room was used for the anesthesiology-related event) may be presented in a lighter, gray font to indicate that the end user cannot yet select to enter data for this particular opportunity. (This specific example receives further elaboration below.)

FIG. 6 includes a “Case Id” data-entry field. By one approach this can comprise an anesthesiology-event case number that uniquely identifies this particular anesthesiology-event record. In this example the program can automatically generate this value as a function of other information that the end user enters. In particular, the program generates this anesthesiology-event case number by combining, at least in part, a numeric identifier for the facility where the anesthesiology-related event occurs, the patient's birth date, and a numeric identifier for the anesthesiology-services provider.

By selecting the “MR Number” data-entry opportunity, the device 100 presents the display shown at FIG. 7. This display presents a data-entry field (shown presently unpopulated) along with a virtual keyboard (shown here in a numbers/symbols format) to facilitate the entry of a medical record number as will typically be provided by the medical facility where the anesthesiology-related event occurs. Upon entering this information the end user selects the “Done” button to return to the display shown in FIG. 6.

Similar displays are provided when the end user selects the “Last Name” and “First Name” data-input opportunities. In those cases, of course, if can be helpful to initially present the virtual keyboard in an alphabetic format (as shown in FIG. 4) to facilitate the entry of alphabetic characters as comprise the patient's names.

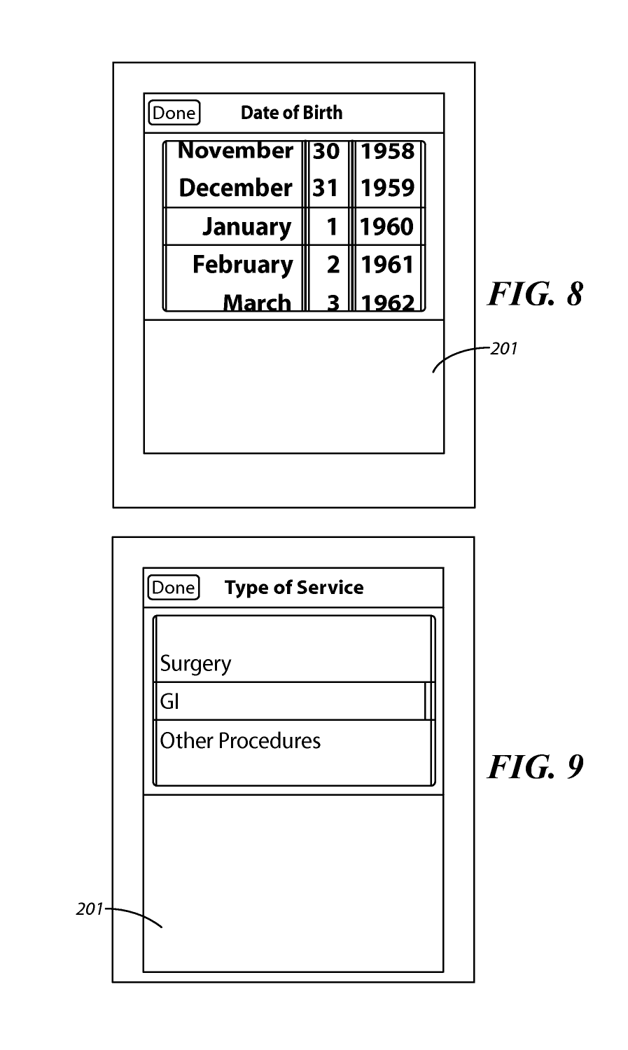

Upon selecting the “Date of Birth” data-entry opportunity the device 100 can present the display shown at FIG. 8. This display includes a calendar wheel having individual wheels for the month, date, and year to facilitate easy keyboardless entry of the patient's birth date. As before, asserting the “Done” button will complete the data entry for this opportunity and return the end user to the FIG. 6 display.

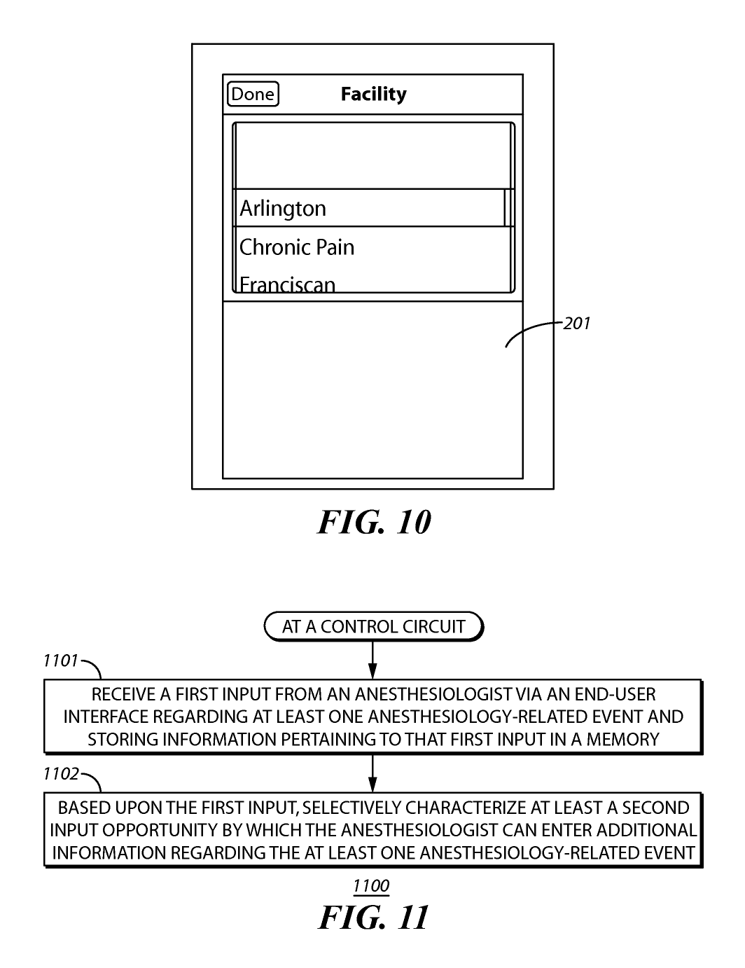

As noted earlier, certain data-entry opportunities can have corresponding pre-populated data entries. In FIG. 6 the “Type of Service” data-entry opportunity has a corresponding default entry, i.e., “Surgery.” To change this entry for this particular anesthesiology-related event record, the end user can tap the “Type of Service” line to view the display shown at FIG. 9. Here, other types of service (either specific, such as “GI,” or general, such as “Other Procedures”) can be selected using, in this illustrative example, a category-selection wheel.

FIG. 6 also notes that the end user can provide information regarding the “Facility” where the anesthesiology-related event occurs and the particular operating room as well. As noted above, in this example the end user cannot enter operating room information until the end user enters information regarding the facility. FIG. 10 illustrates the display to facilitate entering the facility information via a selection wheel. This can comprise pre-populated facility identifiers that represent, for example, the facilities typically served by a particular anesthesiologist or service organization.

These teachings will accommodate having the device 100 selectively characterize subsequent input opportunities based upon one or more previous inputs from the end user. FIG. 11 provides an illustrative general example in these regards. Pursuant to this process 1100, pursuant to a first step 1101 the control circuit 101 receives a first input from an anesthesiologist via the aforementioned end-user interface 103 regarding at least one anesthesiology-related event and stores information pertaining to that first input in the aforementioned memory 102. Then, in a follow-on step 1102 and based upon that first input, the control circuit selectively characterizes at least a second input opportunity by which the anesthesiologist can enter additional information regarding the at least one anesthesiology-related event. For example, that first input can comprise time-based information and the follow-on characterizing can comprise selectively establishing at least one time-based limit to be applied when determining whether to accept the end user's additional information as a valid entry.

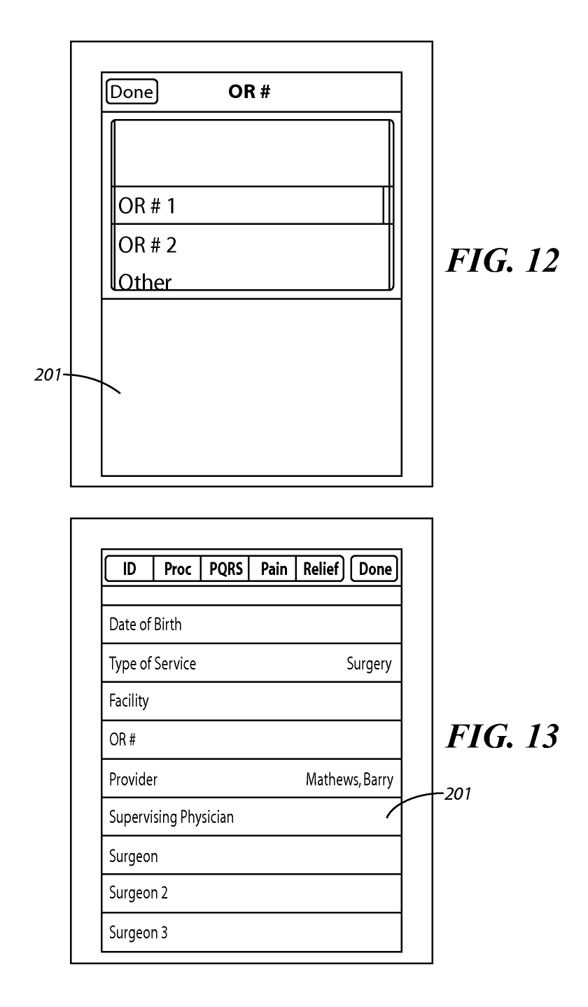

As a further example in these regards, and upon identifying the facility as described above with respect to FIG. 10, the end user can then be permitted to enter information to identify the specific operating room as shown at FIG. 12. In this case, the listed operating rooms have been selectively characterized based upon that earlier identification of the facility in that the selectable operating room numbers match the actual operating rooms that are available at the previously-identified facility. Here, since the selected facility officially has two operating rooms (numbered “1” and “2,” respectively), the device provides those two operating rooms for selection. (An “Other” category is also provided to accommodate the unexpected, as when an anesthesiology-related event may occur elsewhere in the facility to accommodate, for example, some emergency circumstance.) By way of further illustration, if the selected facility instead had three operating rooms, this display would permit the end user to select “OR #1,” “OR #2,” or “OR #3” as well as the “Other” category.

FIG. 11 provides a general overview in these regards.

To continue entering “ID” information as pertains to this anesthesiology-related event, the end user can scroll down further from the display shown in FIG. 6 to reveal more data-entry opportunities as shown in FIG. 13. The “Provider” data-entry opportunity identifies the end user and is automatically populated by the device 100 based upon the end-user's log-in information.

As noted earlier, the end user may require supervision at one level or another. If relevant to the data-entry activity or the record for this anesthesiology-related event, the supervisor's name can be entered via the “Supervising Physician” data-entry opportunity. If the end user has no corresponding supervisor in these regards, this data-entry opportunity can be rendered non-selectable if desired.

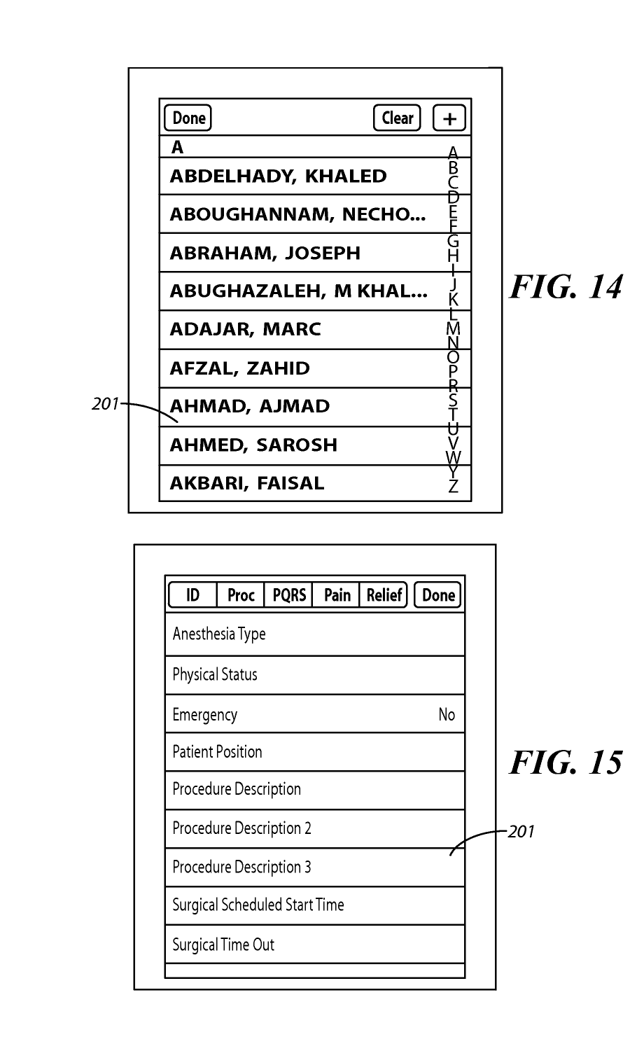

FIG. 13 also illustrates that the end user can enter information to identify the surgeon (or surgeons) who may have been involved in the anesthesiology-related event. By selecting any of these the device 100 can present the user with a display as shown in FIG. 14. The end user can then select from amongst a pre-populated list (alphabetically arranged) of surgeons by name. The alphabet can be presented at the right of the display to permit the end user to quickly move to a different part of the alphabetical listing. By tapping the “+” button the end user can bring up a data-entry field to permit the end user to enter a surgeon who is not otherwise listed.

Regardless of whether the end user first completes all data-entry opportunities for the ID tab, the end user can move on to other tabbed areas. FIG. 15, for example, illustrates some of the data-entry opportunities for the “Proc” tab. As before, some of these data-entry opportunities can be required entries (such as, for example, anesthesia type, physical status, patient position, procedure description, and surgical scheduled start time) and can be highlighted as desired to indicate this status.

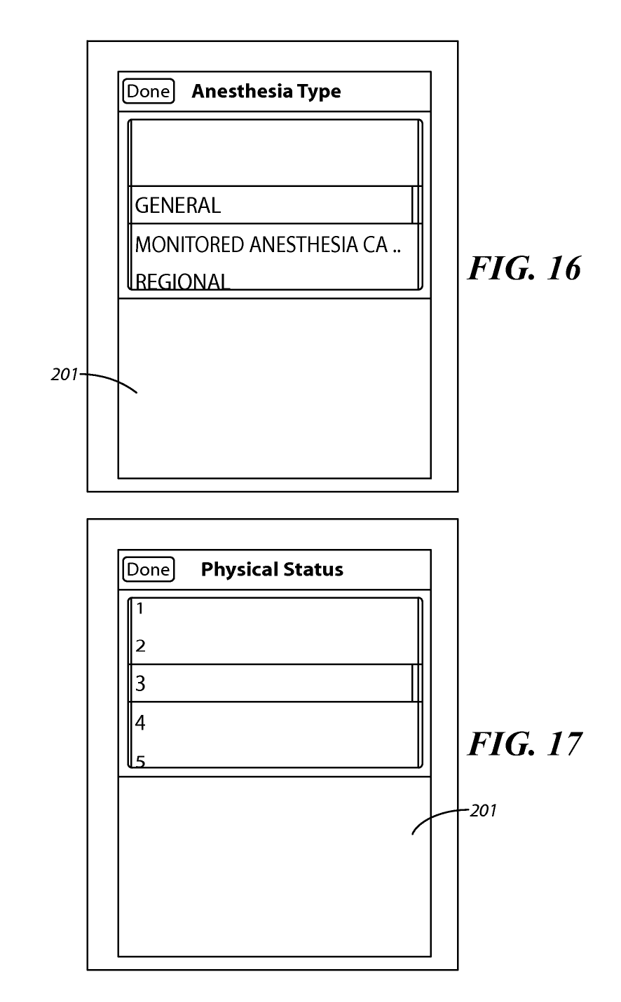

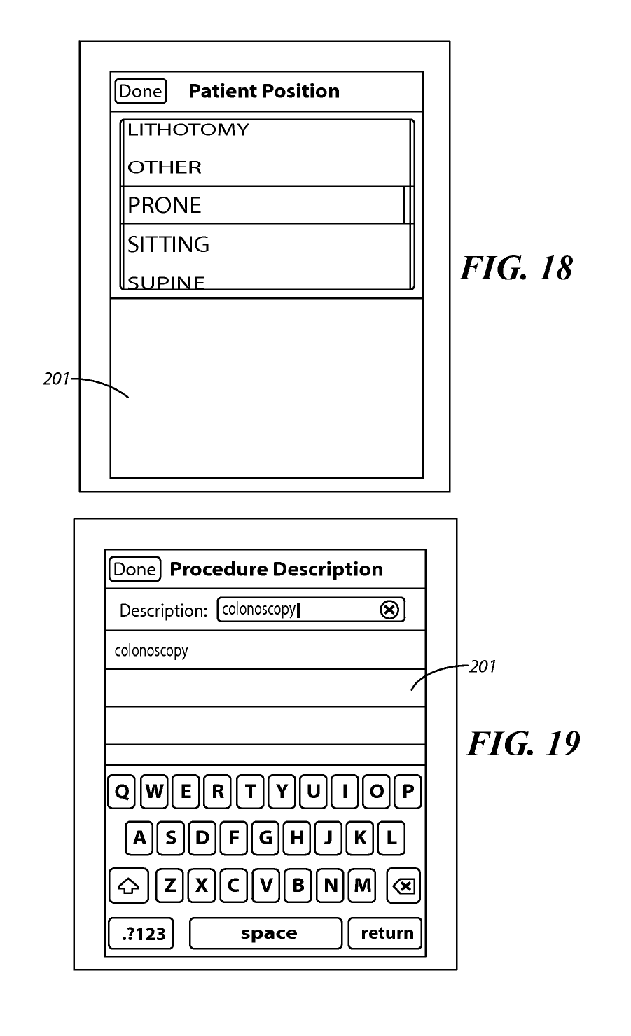

And again, the particular form and substance of a given data-entry opportunity can vary as appropriate. FIG. 16, for example, illustrates the data-entry opportunity as corresponds to the “Anesthesia Type” data-entry opportunity. In this case a wheel-style interface permits the end user to select from amongst a plurality of pre-characterized types of anesthesia. Somewhat similarly, FIG. 17 depicts another use of a wheel-style interface for the “Physical Status” data-entry opportunity (where the end user can characterize the patient's physical status using a scale of “1” to “5”) while FIG. 18 depicts a wheel-style interface for the “Patient Position” data-entry opportunity.

Not all data-entry opportunities are necessarily suitable candidates for a constrained list of predetermined characterizations. Free-text fields can serve well in these instances. FIG. 19, for example, illustrates the use of a free-text field and an available virtual keyboard to permit the end user to enter text to describe or otherwise characterize the medical procedure that occasions the anesthesiology-related event being reported. (Note that the display shown at FIG. 16 permits the end user to enter characterizations or information for a plurality of procedures when such is the case.)

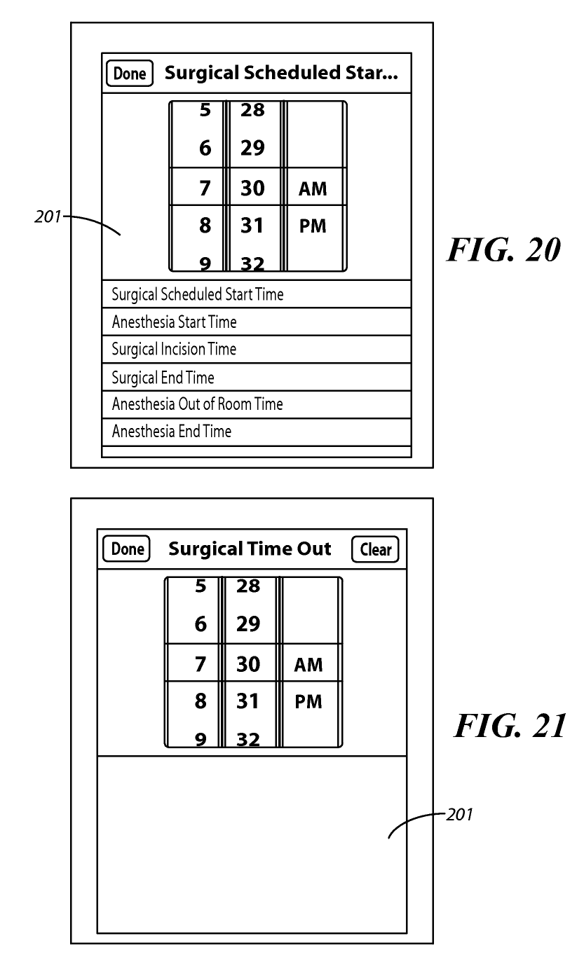

This “Proc” tab (as shown at FIG. 15) includes a “Surgical Scheduled Start Time” data-entry opportunity. FIG. 20 illustrates a useful corresponding display in these regards. In this example the end user employs a number of time-based wheels to easily enter the time at which the surgery/procedure is/was scheduled to begin. FIG. 21 illustrates a similar approach to entering a time-out event during a surgery/procedure. It may be noted that this data-entry opportunity includes a “Clear” button. This is to permit the end user to withdraw from this data-entry opportunity without actually entering any data (as appropriate to the fact that this data-entry opportunity, in this example, is not a required field).

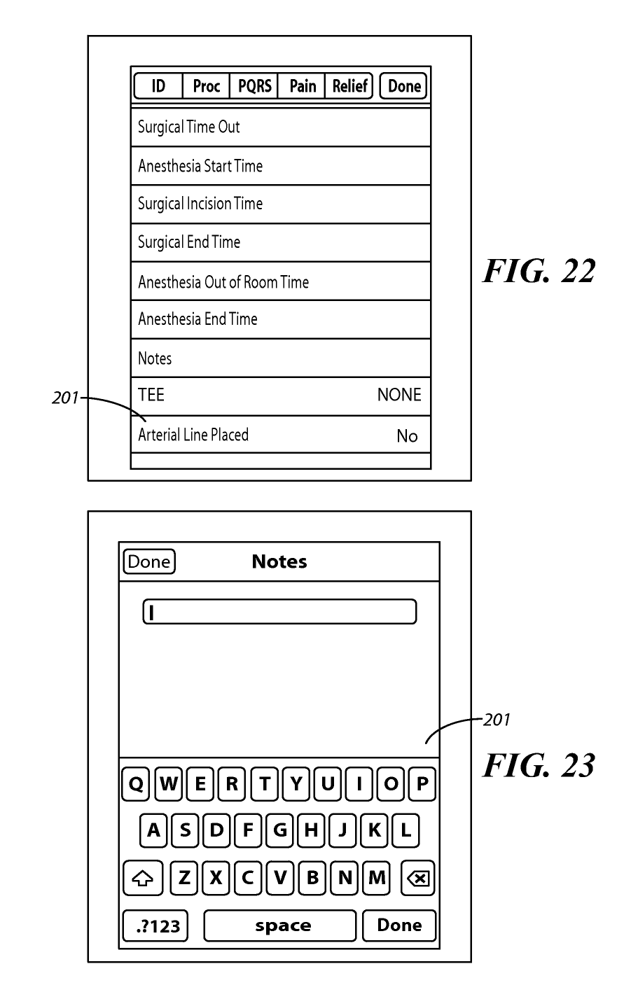

FIG. 22 illustrates additional data-entry opportunities as pertain to the “Proc” tab that are revealed as the end user scrolls down from the display shown at FIG. 16. It will be noted that this includes a number of time-related data-entry opportunities (i.e., anesthesia start time, surgical incision time, surgical end time, anesthesia out of room time, and anesthesia end time). By one approach, each of these identifiers, when selected, can lead to a discrete data-entry area. By another approach, and as illustrated at the previously-mentioned FIG. 20, selecting any of these time-based data-entry opportunities will provide the data-entry mechanism (in this case, the time-entry selection wheels) along with an opportunity to select any of the above-mentioned time-based data-entry opportunities without exiting from this data-entry area. So configured, the end user can save time by avoiding moving back and forth between the general selection screen and the specific data-entry screens.

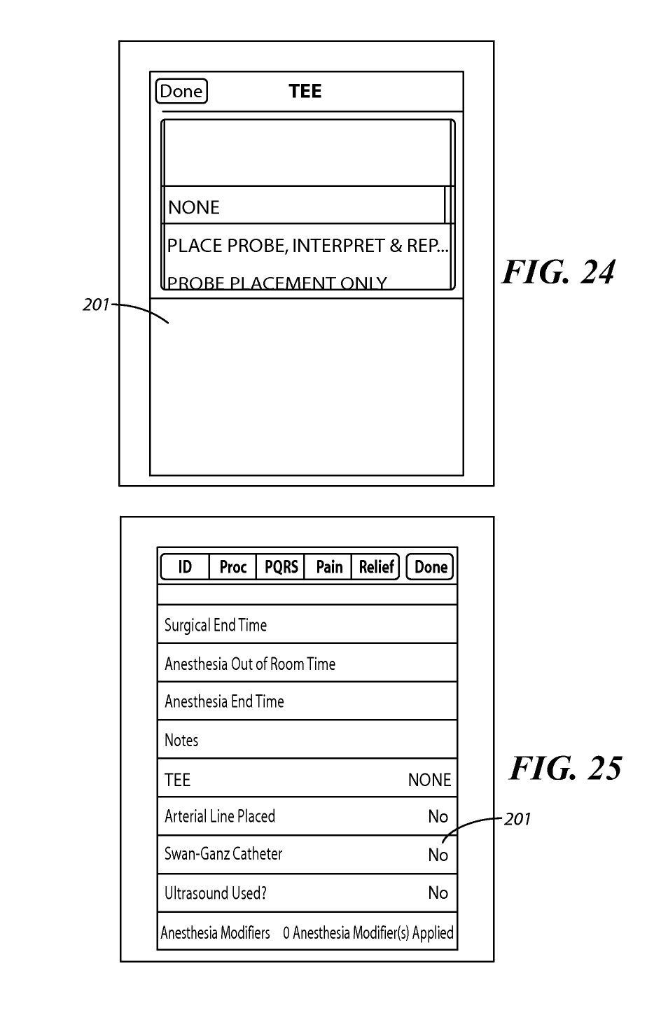

FIG. 23 illustrates a data-entry opportunity that permits the end user to enter free-text notes of their own choosing. This can be especially useful for capturing information regarding observations or events pertaining to the anesthesiology-related event that are not otherwise captured pursuant to the specific data entry activities described herein. FIG. 24, in turn, depicts a data-entry opportunity pertaining to “TEE” (i.e., transesophageal echocardiography). The end user enters data for this non-required data-entry opportunity using a wheel interface that rotates through various relevant choices in these regards.

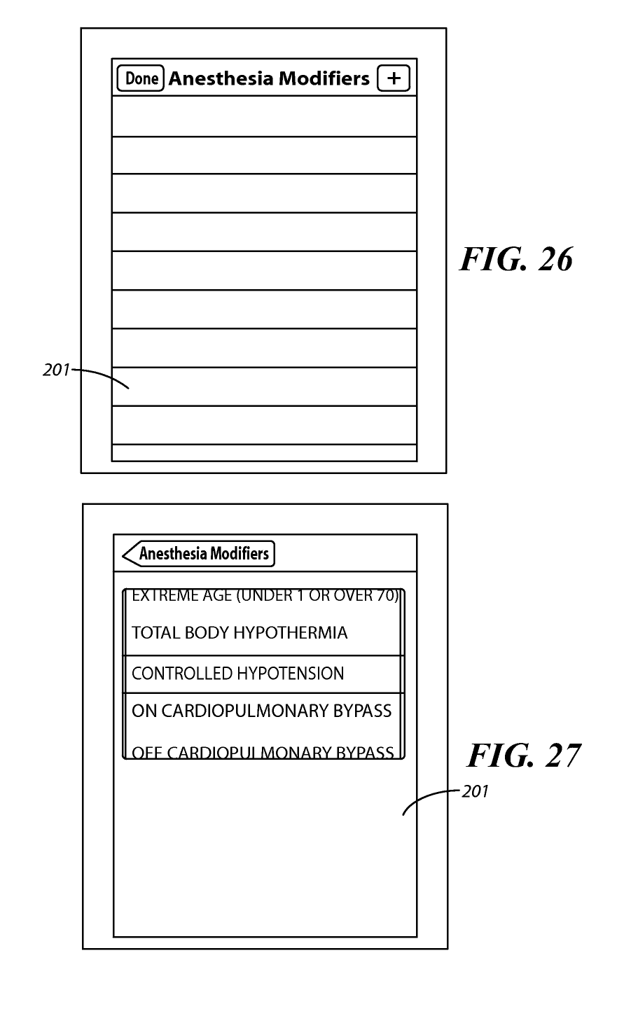

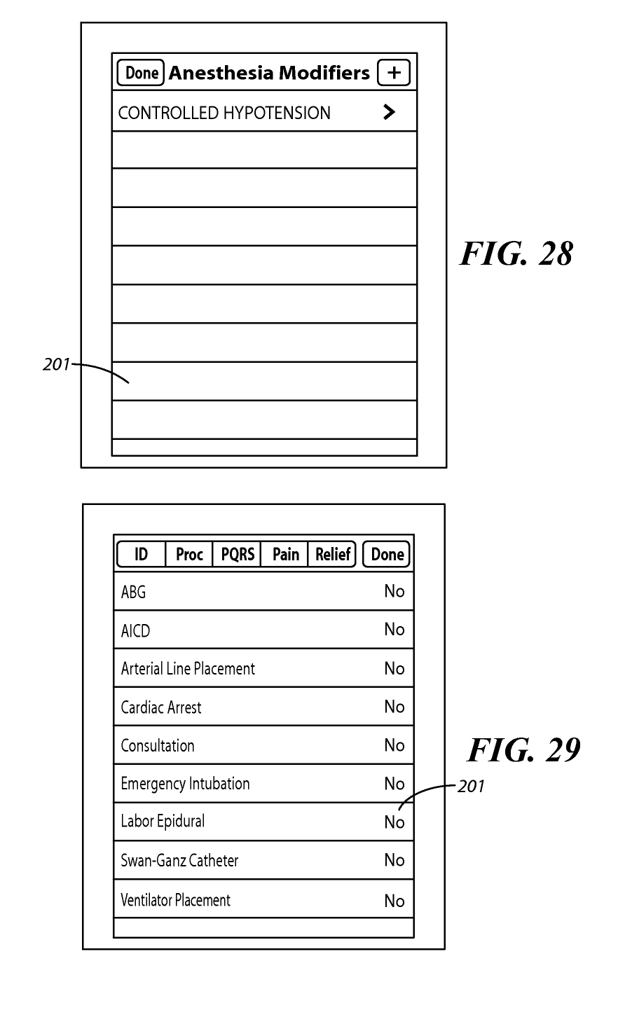

FIG. 25 depicts yet further data-entry opportunities pertaining to procedures (and hence to the “Proc” tab). These opportunities include a number of non-required opportunities having default entries (such as arterial line placed, swan-ganz catheter, and ultrasound use) that can be toggled between “no” (the default value in this example) and “yes” as appropriate. Selecting the non-required data-entry opportunity for anesthesia modifiers leads to the display shown at FIG. 26. To make a selection here, the end user taps the “+” button to reveal the display shown at FIG. 27. The end user then uses the wheel interface to select the appropriate entry and then taps the “Anesthesia Modifiers” button to, in this example, view the display shown at FIG. 28 (which depicts the selected response “Controlled Hypotension”).

The end user can add additional such entries by repeating the foregoing steps. To make a change with respect to an already-selected entry the end user can move their finger back and forth (horizontally) rapidly over the selected modifier to cause a “Delete” button to appear. Tapping that “Delete” button then causes the selected modifier to clear. Otherwise, the end user taps the “Done” button to indicate completion of this data-entry activity.

Returning again momentarily to FIG. 27, in this example one of the selectable modifiers reads, “Extreme Age (under 1 or over 70).” In this example we presume that the patient's birth date as previously entered in fact presents a patient that meets this age requirement. This information regarding the anesthesia patient, in turn, is utilized by the device 100 to provide this corresponding opportunity for the end user to enter pre-defined information regarding age-based anesthesia modifications as a function of the anesthesia patient's age. If the patient's age were not already known to the device 100 to render this selection possibly relevant, this specific selection would not be available as shown.

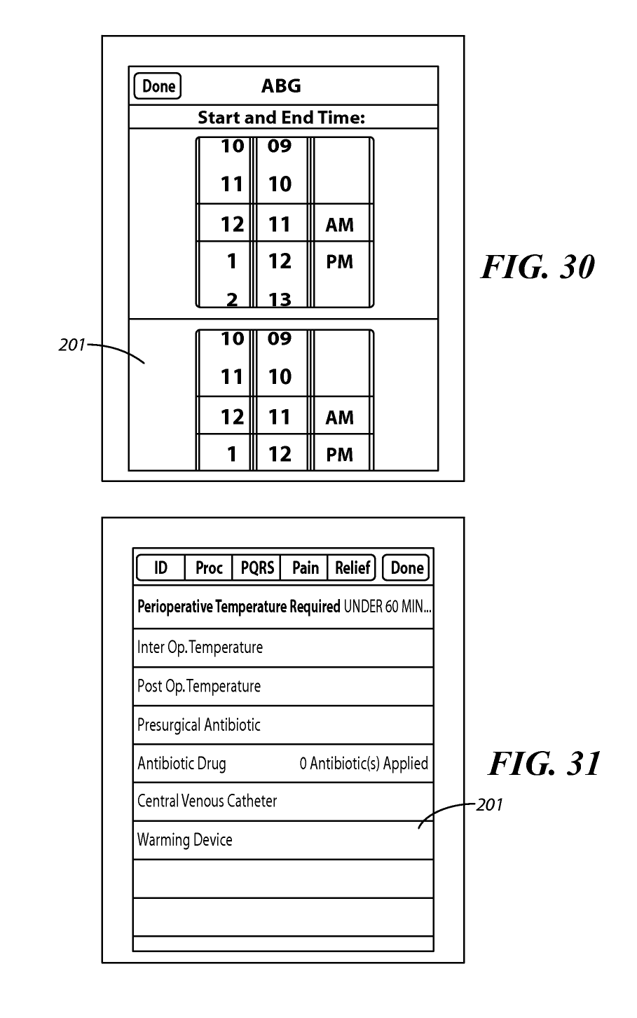

FIG. 29 presents a number of other data-entry opportunities as pertain to procedures. All of these opportunities are presented with a default value of “no.” These teachings will accommodate, as appropriate, permitting the end user to change such a default value to something other than “yes.” For example, selecting the ABG data-entry opportunity leads to the display shown at FIG. 30. Here, the end user employs two sets of time wheels to enter the start and end times as pertain to an ABG circumstance.

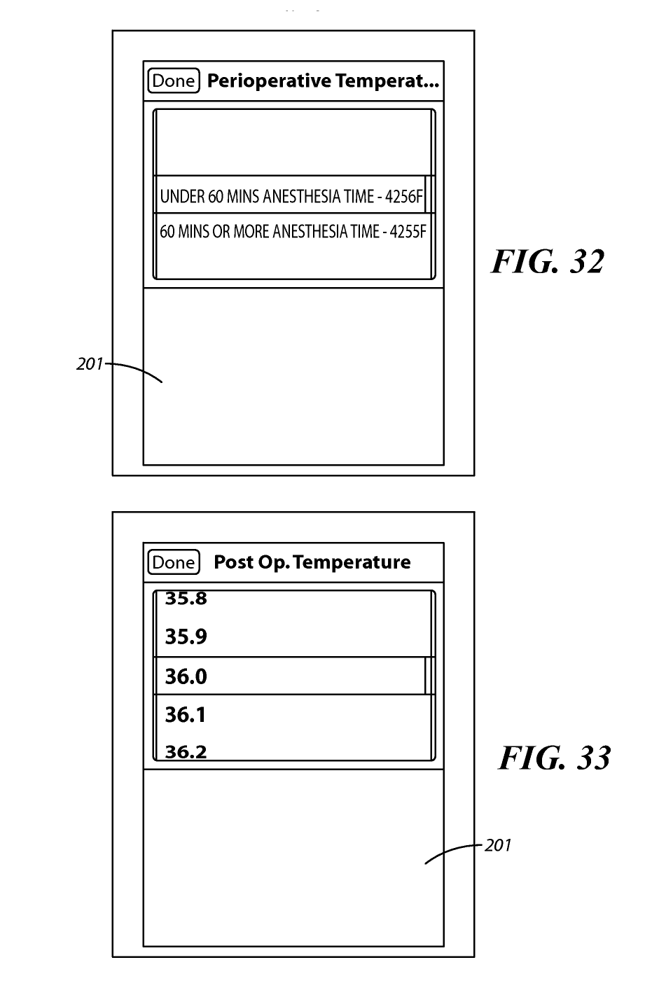

FIG. 31 depicts the data-entry opportunities the end user finds upon selecting the “PQRS” button (where PQRS is an acronym for “physical quality rating system”). In this example the post op. temperature opportunity, the presurgical antibiotic opportunity, the central venous catheter opportunity, and the warming device opportunity are all required entries. The “perioperative temperature required” data-entry opportunity is an optional field and has an automatically calculated value of “under 60 minutes anesthesia time” (the device 100 having calculating this result based upon the anesthesia time entered previously via the “ID” tab). The end user can select this data-entry opportunity, however, and use the resultant display as shown at FIG. 32 to modify this automatically calculated value if desired.

Selecting the data-entry opportunity for the post-operation temperature permits the end user to use a selection wheel (see FIG. 33) to select the correct temperature reading.

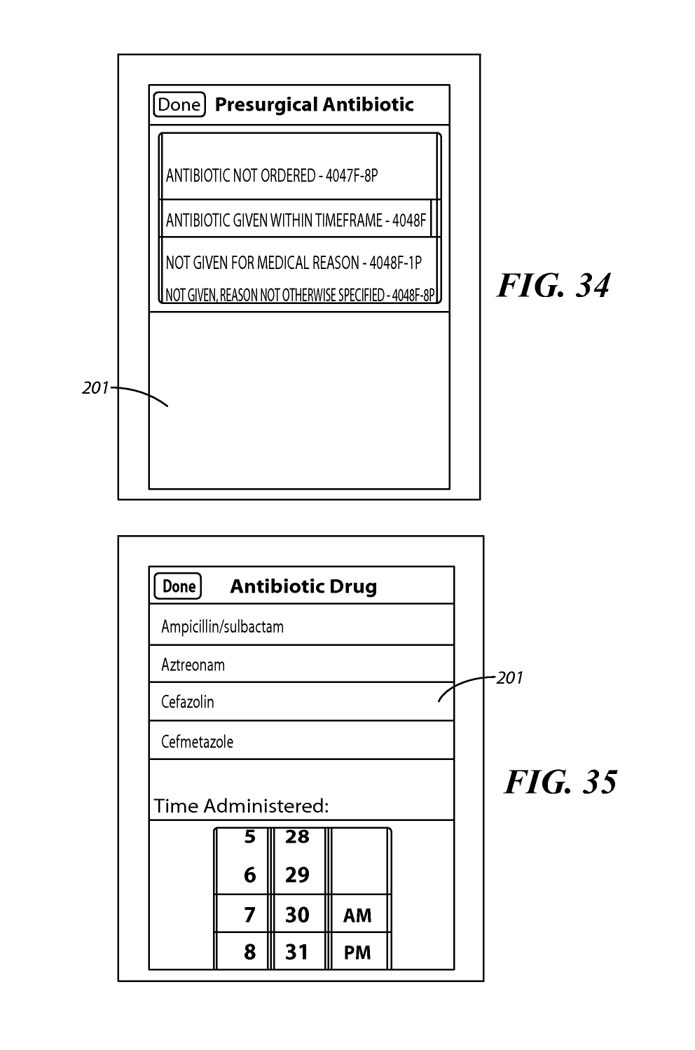

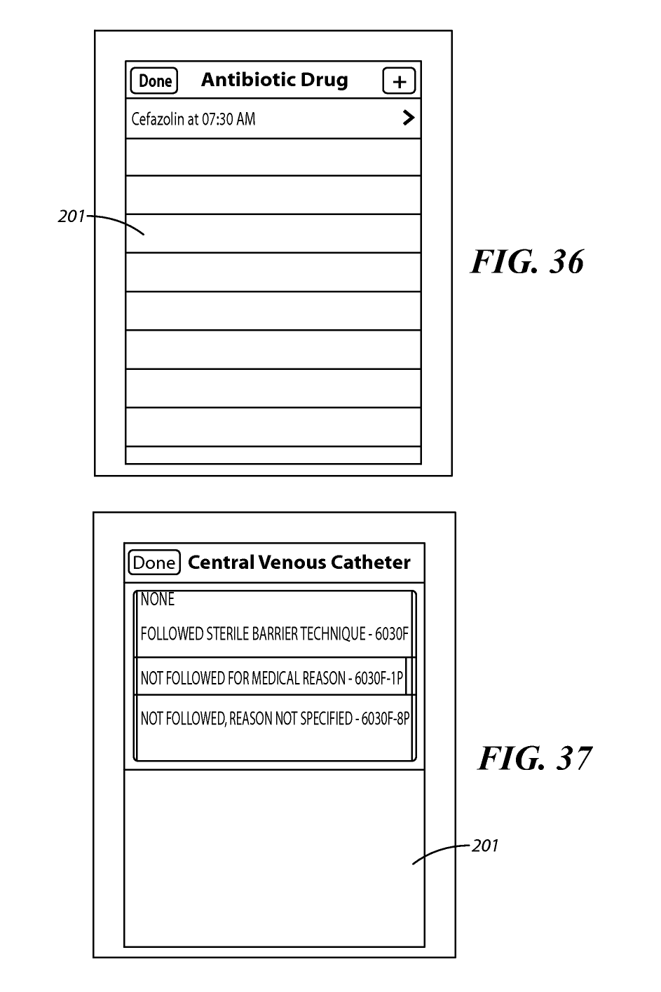

The display shown at FIG. 34 permits the end user to select various entries as pertain to the administration of a presurgical antibiotic. When the end user selects the “antibiotic given within timeframe” entry, in this illustrative example the device automatically takes the end user to the display shown at FIG. 35 to facilitate entering information regarding the administered antibiotic drug. In particular, the drug can be selected from a scrollable list and the time of administration then entered via the selection wheels at the bottom of the display. Pressing “Done” then presents the end user with a display such as the one shown in FIG. 36 that presents the selected drug in combination with the time of administration. The end user can utilize the “+” button to add additional antibiotic drugs to this entry as appropriate.

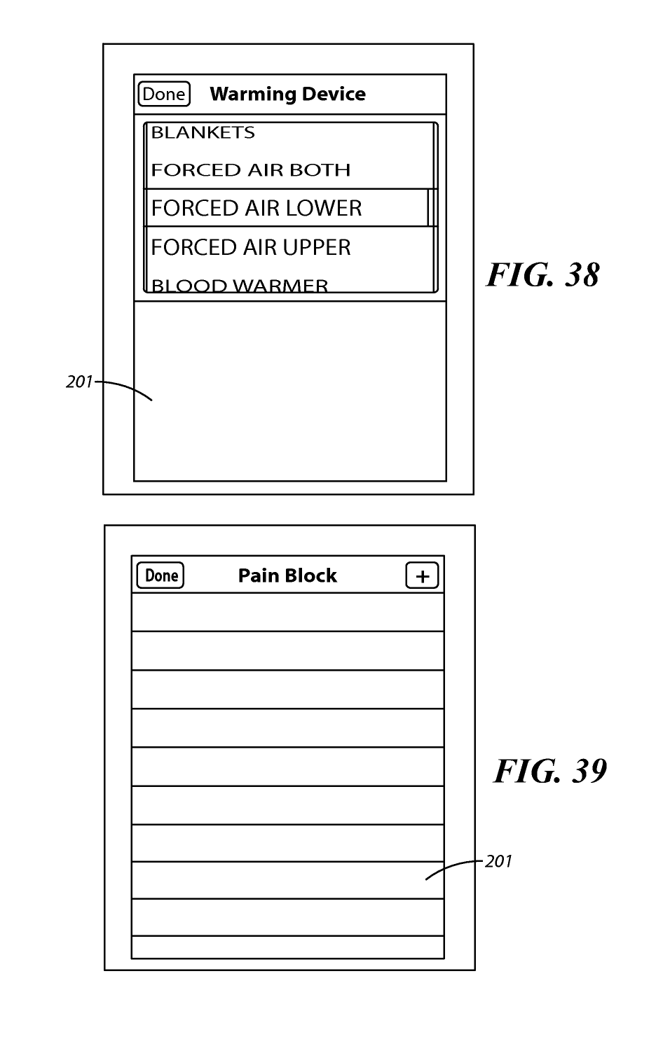

Selecting the “central venous catheter” data-entry opportunity causes the device 100 to present the display shown in FIG. 37 to permit the end user to select an appropriate entry from amongst the selections provided. Similarly, selecting the “warming device” data-entry opportunity causes the device 100 to present the display shown in FIG. 38 to permit the end user to select an appropriate entry in these regards.

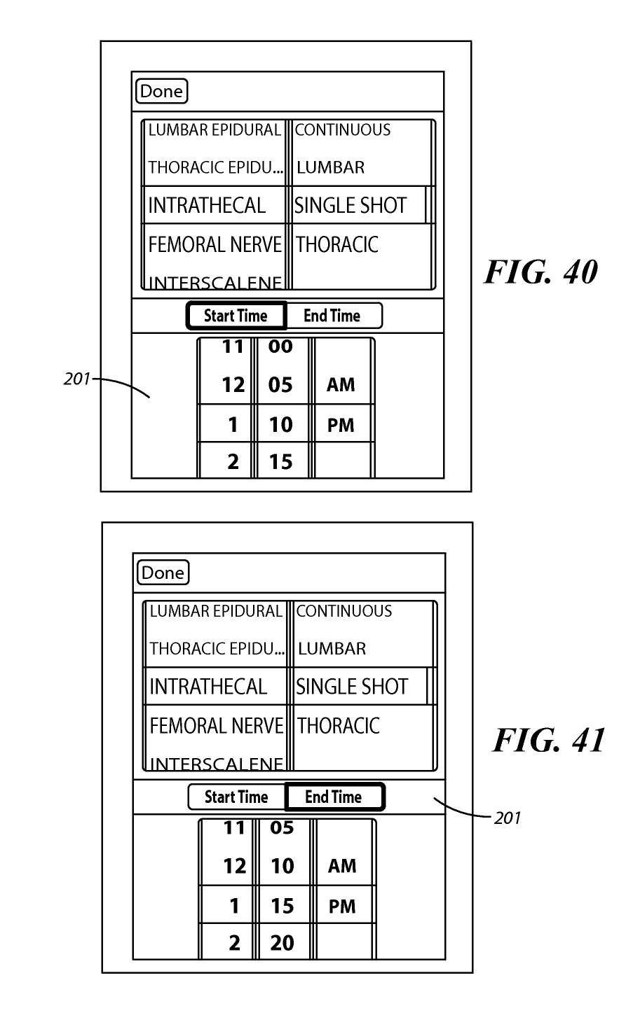

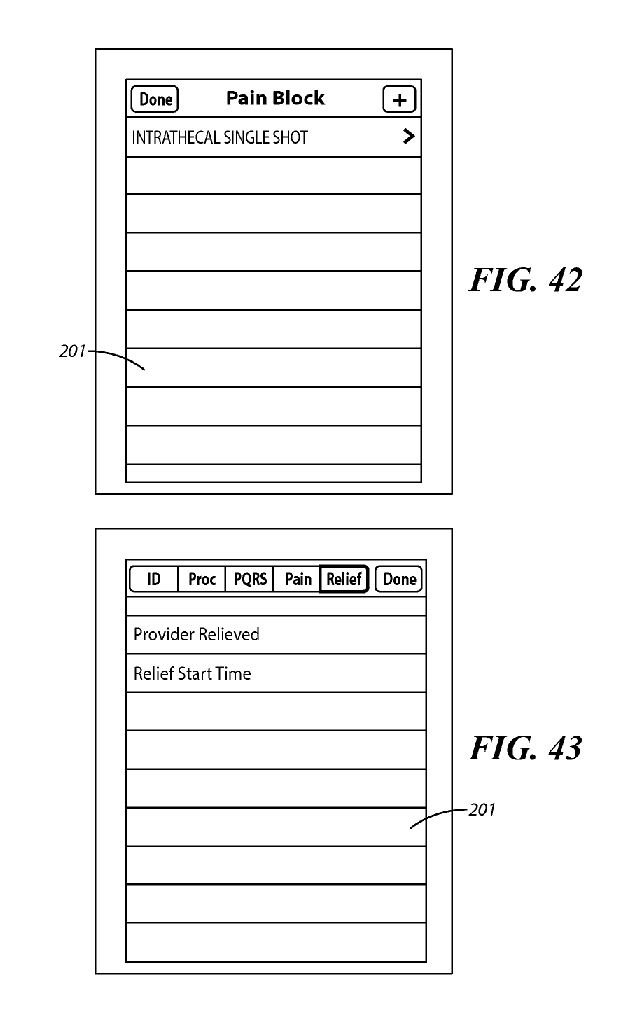

Selecting the “Pain” tab presents the display of FIG. 39. Here, the end user employs the “+” button to enter information regarding pain blocks administered to the patient during or related to the anesthesiology-related event. In particular, pressing the “+” button brings up the display shown in FIG. 40. Here the selection wheels permit the end user to make various selections about the nature and administration of a pain block and to then select a start time for the block as well as (and referring now to FIG. 41) the end time for the block. Touching the “Done” button takes the end user to the selected-entry display of FIG. 42 where the end user's selections in these regards are shown.

As with other such data-entry opportunities the “+” button can again be employed to add other pain-block entries to these results. And again as before, any of these selections can be removed from the consolidation screen (FIG. 42) by rapidly moving one's finger back and forth over the selected entry to bring up a “Delete” button that, when tapped, will remove the corresponding entry.

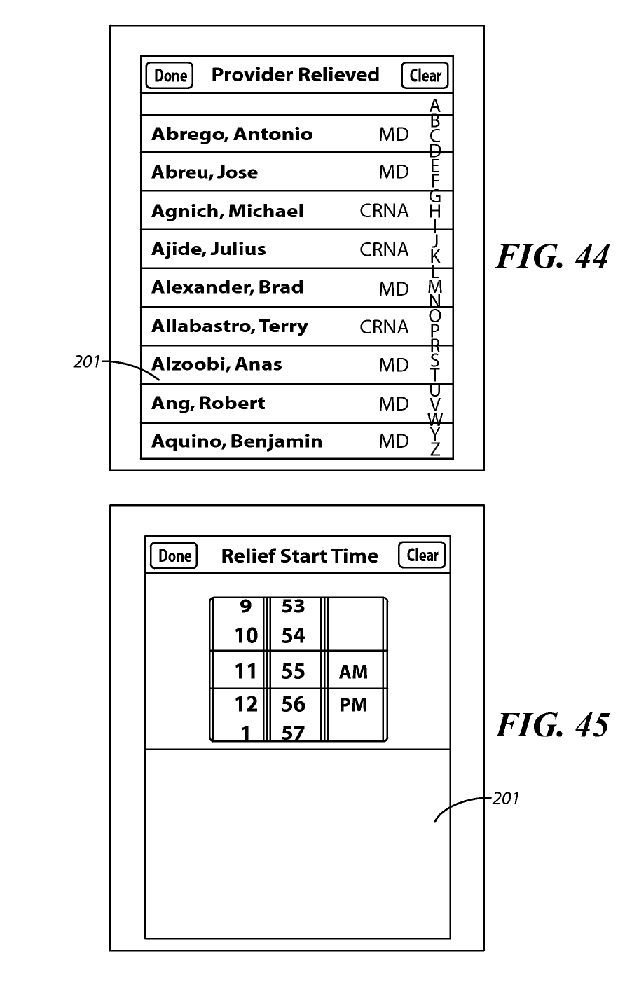

FIG. 42 depicts the two fields that are available as data-entry opportunities in this illustrative example for the “Relief” tab. This reference to “relief” refers to relieving an anesthesiologist from duty for whatever reason. Selecting the “provider relieved” data-entry opportunity brings up the display shown at FIG. 44. Here, the end user can identify the relieved party by name. FIG. 45, in turn, illustrates a data-entry opportunity corresponding to the time when such relief began.

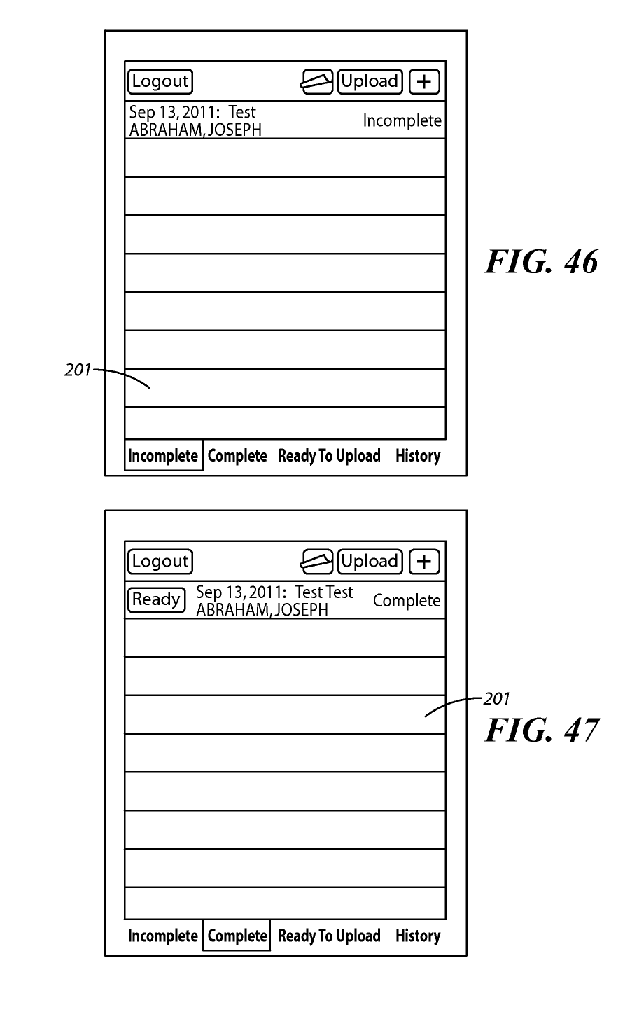

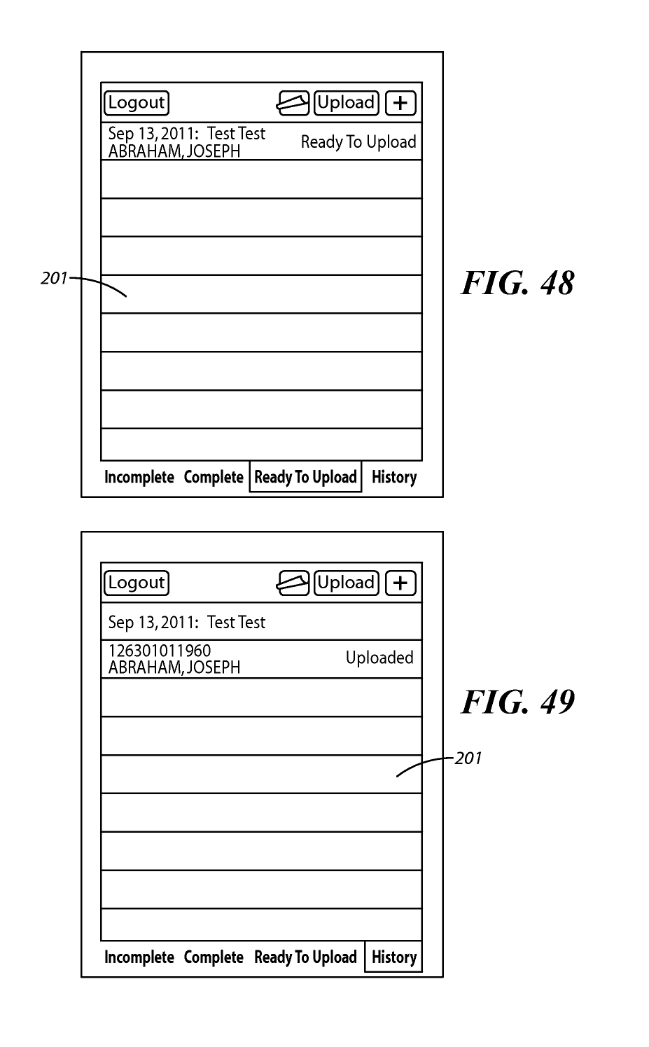

Referring now to FIG. 46, in this illustrative example the bottom of the touch-screen display 201 includes four selectable tabs; “Incomplete,” “Complete,” “Ready to Upload,” and “History.” A report (also referred to as a “case”) not yet completed remains as an incomplete report. Pressing the “Incomplete” tab brings up all incomplete reports within this device 100 for this end user. Here, only a single such incomplete report is shown. To the extent that the list includes too many incomplete reports to display simultaneously, the end user can scroll through the list to find the incomplete report of interest. The end user can select such an incomplete report to access the data-entry opportunities discussed above to thereby complete the data-entry activity.

Once a report becomes “complete” the device automatically moves the report from this listing of incomplete reports to a listing of complete reports as described below. And again, if desired, the end user can be allowed to cancel an incomplete report and thereby remove the incomplete report from the device.

Touching the “Complete” tab brings up the listing of complete reports as shown by way of example at FIG. 47. Here, for the sake of illustration, there is only one complete report. Although this report is complete in that all required data-entry opportunities have an appropriate entry, in this example the end user can select the report to open the report and to gain access to the data-entry opportunities make such changes or supplemental entries as may be appropriate. The end user can also select and cancel a complete report should they wish.

The end user can use the “Ready” button to move a complete report to the ready-to-upload queue. Touching the “Ready to Upload” tab, in turn, will open the listing of reports that are ready to upload. Pressing the “Upload” button will cause the device to utilize its communications capabilities to upload the designated report(s) to, for example, the aforementioned remote server. By one approach this can comprise encrypting part or all of the report's contents prior to uploading this information.

By one approach, the end user can assert this uploading instruction even when no communications access is presently available. In such a case the device 100 can be configured to automatically effect that uploading at the first available opportunity (either with or without notice to the end user of an imminent transmission or a transmission in progress).

By one approach the device 100 can retain a complete copy of all or selected uploaded reports. For many application settings, however, this can be unadvisable. Instead, by one approach, the device 100 can retain only a metadata record of the report following such an upload. This can greatly relieve local storage requirements while preserving the end user's ability to access and review metadata information about the report (such as the name of the report, the date of completing the report, the case number, and so forth).

So configured, these teachings are readily and economically applied in conjunction with various existing enabling platforms. These approaches tend to greatly encourage accurate and timely entry of information by persons who are also often charged with important tasks that offer considerable distractions in these regards. The end user also has considerable flexibility regarding when, how, and in what order to complete their entries while this approach nevertheless assures that all required entries are provided before permitting a report to be rendered “complete” by the end user.

The report(s) provided as per these approaches is also highly leverageable in a variety of ways. For example, much of the information captured is useful when calculating an anesthesiology-patient's bill. Some of the information, however, while not useful when calculating such a bill is nevertheless useful to calculate the compensation owed to the anesthesiologist.

Beyond this, some of the information collected can be repurposed in other ways as well. As one example in these regards, some of the information can provide useful insight into the efficiencies and/or even the relative economic sensibility of certain procedures. The facility and operating theater information contained in such reports, for example, can be readily employed by the facility to readily assess the manner and timing of usage of their operating rooms to determine whether second or third operating rooms are being opened in an economically-sensible manner when perhaps a first already-opened operating room would have sufficed.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. An apparatus comprising:
an end-user interface;
a memory;
a control circuit operably coupled to the end-user interface and the memory, the control circuit being configured to:
receive a first input from an anesthesiologist via the end-user interface regarding at least one anesthesiology-related event and storing information pertaining to that first input in the memory;
based upon the first input, selectively characterize at least a second input opportunity by which the anesthesiologist can enter additional information regarding the at least one anesthesiology-related event.

2. The apparatus of claim 1 wherein the end-user interface comprises a touch-screen display.

3. The apparatus of claim 2 wherein the end-user interface, memory and control circuit share a housing having a tablet-based form factor.

4. The apparatus of claim 1 wherein the control circuit is further configured to automatically generate an anesthesiology-event case number that correlates to the anesthesiology-related event by combining, at least in part:
an identifier for a facility at which the anesthesiology-related event occurred;
a patient's birth date;
an anesthesiology-services-provider identifier.

5. The apparatus of claim 1 wherein the control circuit is further configured to log-in the anesthesiologist as a previously-authorized user.

6. The apparatus of claim 1 wherein the first input comprises information regarding a facility at which the anesthesiology-related event occurred, and wherein selectively characterizing at least a second input opportunity by which the anesthesiologist can enter additional information regarding the at least one anesthesiology-related event comprises, at least in part, providing input opportunities for operating rooms that correspond only to operating rooms that are specific to the facility.

7. The apparatus of claim 1 wherein the first input comprises information regarding the anesthesiologist and wherein selectively characterizing at least a second input opportunity by which the anesthesiologist can enter additional information regarding the at least one anesthesiology-related event comprises, at least in part, selectively permitting and prohibiting the anesthesiologist from entering the additional information as a function of supervisory requirements that pertain to the anesthesiologist.

8. The apparatus of claim 1 wherein the first input comprises information regarding an anesthesia patient and wherein selectively characterizing at least a second input opportunity by which the anesthesiologist can enter additional information regarding the at least one anesthesiology-related event comprises, at least in part, providing an opportunity for the anesthesiologist to enter pre-defined information regarding age-based anesthesia modifications as a function of the anesthesia patient's age.

9. The apparatus of claim 1 wherein the first input comprises time-based information and wherein selectively characterizing at least a second input opportunity by which the anesthesiologist can enter additional information regarding the at least one anesthesiology-related event comprises, at least in part, selectively establishing at least one time-based limit to be applied when determining whether to accept the additional information as a valid entry.

10. The apparatus of claim 1 further comprising:
a communications interface operably coupled to the control circuit;
wherein the control circuit is further configured to upload a report regarding the anesthesiology-related event reflecting at least some of the inputs from the anesthesiologist.

11. The apparatus of claim 10 wherein the communications interface comprises a wireless communications interface.

12. The apparatus of claim 10 wherein the control circuit is further configured to automatically locally retain only a metadata record of the report regarding the anesthesiology-related event following the upload.

13. The apparatus of claim 10 wherein the report includes, at least in part:
information useful to calculate an anesthesiology-patient bill; and
information useful to calculate compensation for the anesthesiologist but not useful to calculate the anesthesiology-patient bill.

14. A method comprising:
at a control circuit:
receiving a first input from an anesthesiologist via an end-user interface regarding at least one anesthesiology-related event and storing information pertaining to that first input in a memory;
based upon the first input, selectively characterizing at least a second input opportunity by which the anesthesiologist can enter additional information regarding the at least one anesthesiology-related event.

15. The method of claim 14 wherein the first input comprises information regarding a facility at which the anesthesiology-related event occurred, and wherein selectively characterizing at least a second input opportunity by which the anesthesiologist can enter additional information regarding the at least one anesthesiology-related event comprises, at least in part, providing input opportunities for operating rooms that correspond only to operating rooms that are specific to the facility.

16. The method of claim 14 wherein the first input comprises information regarding the anesthesiologist and wherein selectively characterizing at least a second input opportunity by which the anesthesiologist can enter additional information regarding the at least one anesthesiology-related event comprises, at least in part, selectively permitting and prohibiting the anesthesiologist from entering the additional information as a function of supervisory requirements that pertain to the anesthesiologist.

17. The method of claim 14 wherein the first input comprises information regarding an anesthesia patient and wherein selectively characterizing at least a second input opportunity by which the anesthesiologist can enter additional information regarding the at least one anesthesiology-related event comprises, at least in part, providing an opportunity for the anesthesiologist to enter pre-defined information regarding age-based anesthesia modifications as a function of the anesthesia patient's age.

18. The method of claim 14 wherein the first input comprises time-based information and wherein selectively characterizing at least a second input opportunity by which the anesthesiologist can enter additional information regarding the at least one anesthesiology-related event comprises, at least in part, selectively establishing at least one time-based limit to be applied when determining whether to accept the additional information as a valid entry.

19. The method of claim 14 further comprising:
uploading a report regarding the anesthesiology-related event reflecting at least some of the inputs from the anesthesiologist.

20. The method of claim 19 further comprising:
automatically locally retaining only a metadata record of the report regarding the anesthesiology-related event following the upload.
